(19) United States
(12) Patent Application Publication
(10) Pub. No.: US 2005/0236253 A1
(43) Pub. Date: Oct. 27, 2005

(54) Centralized management system for bulk-vending machines utilizing wireless telecommunications technology

(76) Inventor: Lindsay Anne Shur, Keansburg, NJ (US)

Correspondence Address: LINDSAY A. SHUR, P. O. BOX 705, HOLMDEL, NJ, 07733, US

(21) Appl. No.: 11/131,861

(22) Filed: May 18, 2005

Related U.S. Application Data
(63) Continuation-in-part of application No. 10/132,479, filed on Apr. 25, 2002, now Pat. No. 6,912,448.

(51) Int. Cl. G07F 11/00

(52) U.S. Cl. 194/200

(57) ABSTRACT

The first component of this invention enables management to remotely determine the cash and inventory status of each dispensing unit within their bulk-vending machines. Within each bulk-vending machine, data collection modules are invented which operate in conjunction with a wireless companion module, to transmit information regarding the status of each vending machine to management. The second component of this invention utilizes the cash and inventory status of the machines to dynamically allocate part-time and full-time employees to service routes. The dynamically generated service routes are simultaneously dependent on the status of the machines, the skill level of the employees, and the hours of availability of part-time and full-time employees and the hours of availability of the sites where the machines are located. The algorithm is not constrained to just the bulk-vending machine business.

### PRIORITY FILING

This application claims priority of U.S. Provisional application Ser. No. 10/132,479 filed on Apr. 25, 2002 and entitled, “Centralized Management System for Bulk-Vending Machines Utilizing Wireless Telecommunications Technology”.

### FIELD OF INVENTION

This invention extends remote centralized wireless management to bulk-vending machines and specifies an end-to-end centralized management system that can be utilized by all types of vending machines.

Data collection modules for bulk mechanical vending machines are specified. Such modules enable remote centralized management of cash and inventory status, which allows large corporations to penetrate the bulk vending machine business; as opposed to being primarily limited to sole proprietary ownership (as currently exists).

Cash and inventory status data is transmitted from the vending machines to the centralized management system using wireless communications technology, or wired technology if so desired.

An algorithm to generate dynamic service routes according to the status of machines, the hours part-time/full-time employees are contracted work as well as the times the machines are accessible (which depends on the business hours of the site at which each machine is located) is invented.

Utilizing state-of-the art Global Positioning Satellite mapping software, the dynamic service routes automatically generate directions and detailed maps (if requested) so that employees can “hit the road” immediately.

### BULK-VENDING MACHINE INVENTION: BACKGROUND

The management of modern bulk-vending machines cannot be remotely executed via centralized communications systems. The issue arises from the fact that the machines do not record the cash collected, or the amount dispensed. Such data requires calculation from the volume of product remaining in each dispensing unit. Cash/dispensing information is critical to the centralized management of the vending business. Since remote data collection is not readily available in modern bulk-vending machines, centralized communication management systems have not been developed/patented/proposed for this business.

The present invention extends the centralized communication systems that have been developed/patented/proposed for pre-bagged/canned/bottled vending machines. Specifically, this invention defines a data-recording module for each dispensing unit that stores critical bulk-vending data. The data-recording module has a wireless companion module that allows the remote bulk-vending machines to communicate with a centralized management system. Such an invention allows the centralized manager to evaluate the status of a bulk-vending machine remotely.

The significance of this invention allows large corporations to enter the bulk-vending business since management can remotely determine the cash that is being collected from each machine. The inability to independently monitor the cash collected from the machines has impeded large corporations from entering the bulk-vending business. This has occurred despite the fact that marginal profits on bulk products are substantially more for those on packaged goods.

For the pre-bagged/canned/bottled vending machine, the amount dispensed is fixed and the price changes according to the product and vending management decisions. For the bulk-vending machine, the price is fixed and the vending management adjusts the amount dispensed by adjusting the size of the internal dispensing compartment. The nature of these businesses is inherently different.

Modern bulk-vending machines are lightweight, manufactured from durable PVC products, and do not require the service operator to have a truck. Modular design is the trend with the bulk candy dispenser being above the coin-receiving mechanism. Machines can be pre-assembled and transported in a car, or partially assembled, transported in a small car, and then fully assembled on site. Broken modules can be repaired or replaced easily with few skills needed. No electrical hook-ups are required. The portability of the machines allows the machine to be transported to an alternate location if the current location becomes unprofitable for some reason.

The simplicity of the bulk-vending machine means that the machines are inexpensive and entry into the vending business is relatively easy. The simplicity of design also requires few skills for servicing. Maintenance of the bulk canisters and repair of machine modules can be done in a centralized location, where skills may be different and managed more efficiently.

The setting of the internal compartment of each dispensing unit can be managed at the centralized location, since the dispensing unit is part of the canister removed at service. The major concern in the bulk-vending business is that the number of collected coins varies according to the dispensing unit setting within each canister. It is lengthy to determine the number of coins that should be in the coin tray at the time of service. For startups, the owner tends to collect the money preventing disputes concerning the amount of money that was in the machine. Should the owner wish to delegate the servicing responsibility to an employee or contractor, this issue impedes business efficiency.

In this invention, a data-recording unit with a wireless communication companion module within the bulk-vending machine is described. Such an invention allows centralized management of numerous bulk-vending machines via wireless technology communication, or wired technology if so desired.

Communication can be initiated by the on-site bulk-vending machine or by the centralized system.

### BULK VENDING MACHINE INVENTION: SUMMARY

The invention utilizes a data collection module, which can operate in conjunction with a wireless companion module to transmit information regarding a vending machine to a central location to enable management to determine the cash and inventory status of each dispensing unit within a bulk-vending machine. This allows servicing of the business to be delegated to low skilled employees who replace the canisters and return them to the centralized location for cleaning and re-stocking.

In addition, this centralized management wireless communication system may dynamically manage service routes according to the status of machines, the hours part-time/full-time employees are contracted work as well as the times the machines are accessible.

This invention also allows jams to be remotely detected since the invention basically utilizes a counter, which is coupled to the gear mechanism of the dispensing machine and provides a count for every coin inserted. The count is compared with programmable indicia in a microprocessor to determine when the signal is to be transmitted to the central location. For example, if the counter has not changed over period that is a longer interval than normal, a signal is transmitted to the central location that this machine needs attention for a possible jam.

Machines becoming low on supplies can be detected since the count can be compared with programmable indicia in a microprocessor to determine how many coins have been collected, and if the number of coins is reasonably large then a signal is transmitted to the central location indicating the supply level is somewhat low.

The wireless communication module of each vending machine could incorporate state of the Global Positioning Satellite software so that the location of the machine is known to the centralized management system.

In this manner, the central location can also have trained employees to repair the modules and manage the inventory business so that travel between the location of the vending machine and the central headquarters is minimized.

### DYNAMIC SERVICE ROUTE ALGORITHM INVENTION: SUMMARY

The bulk-vending machines proprietors generally have STATIC service routes to service their machines. However, such routes are extremely inefficient since the variation in consumption of products is extraordinarily different from site to site. Service routes need to be driven by the status of machines and such information is readily available from the data collection modules defined above for bulk-vending machines, or prior inventions for pre-bagged/canned/bottled vending machines

As employee benefit costs, especially healthcare, continue to rise, the part-time employee alternative is a critical element of cost control. Hours of part-time employees can vary greatly as servicing a bulk-vending machine is an ideal part-time job for students and retirees.

There are numerous algorithms for generating the best service route in the mathematical literature based on the distance between locations. These algorithms are referred to as the Traveling Salesman Problem and its derivatives. The Traveling Salesman Problem has been modified to account for the opening and closing hours of the sites to be serviced.

In the literature, it is generally assumed that employers have control of the hours of their employee and it is the accessibility of the site for service is the dominant constraint. Typically, there are deadlines of delivery at the site (appropriate for such operations as Federal Express or United Parcel Service) that are the primary concern of the business and the driving motivation of the algorithm.

The vending machine business is, however, inherently different since there are no deadlines of delivery. In addition, machines are deployed in police stations (which are accessible at all times) and can be serviced by part-time students and/or retirees which may have very variable working hours.

The distance between locations is readily obtained through the Global Satellite Position of the wireless communication module of each machine and thus the shortest route to service all the appropriate machines (ignoring any employee or site availability constraints) can be obtained from implementations of the Traveling Salesman Problem, which are abundant in the mathematical and computer science literature.

This invention extends the Traveling Salesman Problem theory by proposing an interactive and iterative algorithm to incorporate the time constraints of employees and opening hours of on-site locations so that DYNAMIC service routes can be generated on a daily or weekly basis, or at whatever frequency management desires.

Once the service route for each employee is determined, travel directions are provided using state of the art Global Positioning Satellite mapping software.

The incorporation of Global Positioning Satellite mapping software into the centralized management system is an important business element in the generation of service routes. Without it, employees need to consultant maps and get directions before embarking on their service routes. Such travel discussions can negate the efficiency gained from optimizing daily service routes. With automatically generated directions dynamic service route management becomes a business reality.

### BULK VENDING MACHINE INVENTION: DRAWINGS

Overview

FIG. 1 is a block diagram in flow chart format depicting the operation of a prior art vending machine.

FIG. 2 is a block diagram in flow chart format depicting the operation of a vending machine according to the present invention.

FIG. 3 is a block diagram depicting a multiple canister vending machine employing the present invention.

FIG. 4 is a block diagram and partly in schematic form depicting the operation of the present invention in conjunction with a vending machine.

### BULK VENDING MACHINE INVENTION: DETAILED DESCRIPTION

The modern bulk-vending machine has a dispensing unit with internal compartments that are adjusted according to the product being sold. An example of such a machine in regard to a single canister is shown in FIG. 4. The internal compartment of dispenser units change depending on the product being sold, for example, the setting for pistachios is about twice that of M&M Milk Chocolates Pieces so that the consumer feels that the dispensed amount is generous and sales are repeated. The internal compartment is the volume of candy or other items that would be dispensed when the appropriate coin is received.

The coin-receiving unit of a bulk-vending machine will accept only one coin type. Certain pieces of candy, for example, occupy the same volume as multiple pieces of additional candy, as for example, one M&M Peanut as compared to multiple pieces of M&M Milk Chocolates.

Repeated sales are the key to success in any business; receiving two pieces of candy may be seen as a “rip off” by the consumer and result in a few repeated sales. Repeated sales drives inventory turn over. Bulk-vending machines with low repeated sales have high inventory, spoilage and low profits.

State of the art bulk-vending machines have multiple removable canisters, which are changed at the time of service. Product changes often result in temporary increased sales since the new items generate consumer curiosity.

Each bulk-vending canister has a separate coin-receiving mechanism. A consumer purchasing a product inserts the appropriate coin into the coin slot and returns an external dial on the coin-receiving mechanism. The external dial rotates an internal coin-receiving gear that meshes into the compartment gear of the dispensing unit. The dispensing compartment gear rotates the internal compartment gear over the chute, the product falls and is retrieved by the consumer.

Bulk-vending machines are inherently different from package vending machines, since mechanical simplicity and minimum maintenance are critical. Only one type of coin is accepted by the coin-receiving mechanism of a bulk-vending machine. Such bulk-vending machines are known in the art; an interchangeable canister bulk-vending machine is sold under the trademark Vendstar 3000, for example.

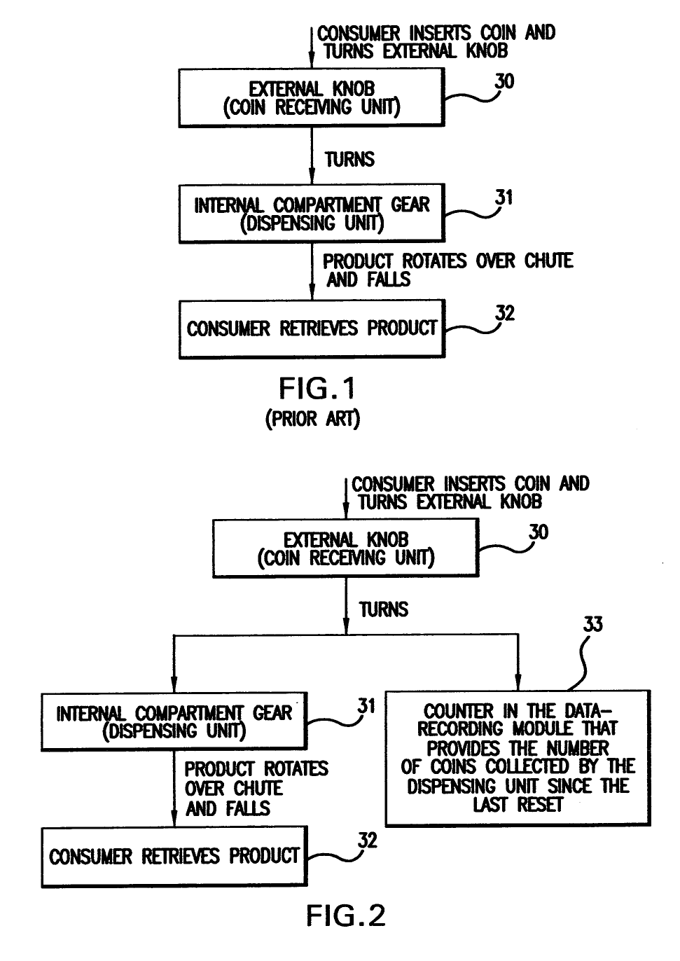

Referring to FIG. 1, there is shown a typical flow chart of operation of a bulk-vending machine according to the prior art. A consumer inserts a coin into the machine and turns an external knob, the external knob has a coin-receiving unit depicted by module 30. The rotation of the knob, which is unlocked by the deposit of a coin, enables an internal compartment gear to operate as shown in step 31. This is a dispensing unit. The dispensing unit turns a table to an opening, rotates over the chute and falls through the dispensing slot, where the customer receives the product as indicated by reference numeral 32. This is a simple operation.

Referring to FIG. 2, there is shown a simple block diagram of the present invention. It is noted that the invention operates according to the prior art in that modules 30, 31 and 32 all perform the same function. As seen, there is an additional module 33, which basically is a counter, which is contained in the data recording module. The counter provides the number of coins collected by the dispensing unit since the last reset, as will be explained in greater detail.

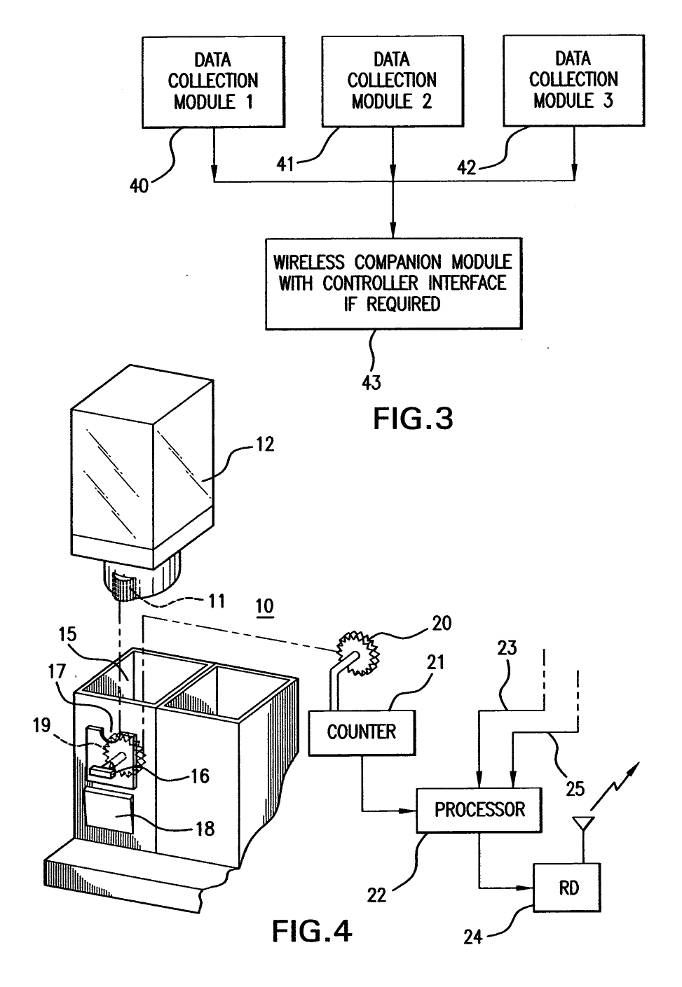

FIG. 3 shows that a multiple dispensing machine, which has multiple data collection modules concerned with multiple canisters as 40, 41 and 42, can all be connected to a wireless companion module 43 with a controller interface, if required, whereby the data can be transmitted through a wireless link, as will be further explained.

Essentially, and according to this invention, and as depicted briefly in regard to FIG. 2, the actual number of coins collected per dispensing unit is essential to any information that is stored or collected by the bulk-vending machine. The information and perhaps derivatives (set manually or remotely), can then be communicated to the vending management by a battery operated wireless companion module (or wired module, if so desired) deployed within the bulk-vending machine, as will be further described.

As indicated, and is shown in FIGS. 2 and 3, the coin-receiving mechanism accepts only one type of coin. For example, the coin can be 25 cents and so on. Counting the number of coins is critical to any data collection for a bulk-vending machine. The present invention, as depicted in FIG. 2, proposes that the gear driving the internal dispensing compartment also turns a counter that records the number of coins collected since the counter was last reset. The coin-receiving mechanism is a pin module on the front of the bulk-vending below the dispensing unit. Behind the coin-receiving mechanism module is the chute, which funnels the product from the back of the dispensing unit to the front of the machine for the consumer to retrieve. A few inches below the chute funnel is the coin tray, where the coins gather until the service call. This is, of course, widely understood in the prior art and the operation of bulk-vending machines is well known.

In any event, as one can ascertain, there is considerable space below the dispensing unit to attach a data collection module and a wireless module according to this invention within the machine. The wireless companion module interfaces with the data collection module and reads the counter and other information, if appropriate. It is more efficient for the wireless module to reside within just one of the coin-receiving units and have a controller to interface with the multiple data collection modules for bulk-vending machines that have multiple canisters.

As will be explained in conjunction with FIG. 4, the centralized vending machine management system comprises a computer or telephone or other wireless technology (or wired technology, if so desired) which could be deployed within the machine to determine the approximate status of the machine. The wireless companion module uniquely identifies the machine and its location using Global Positioning Satellite (or similar technology) software as well.

The actual information communicated to and from the centralized vending management system can be very simple or complex, but such data is derived from the coins deposited. If the number of coins collected exceeds certain thresholds (indicating low inventory) or remains unchanged for a certain period (indicating a jam) then the wireless companion module would initiate a call to the centralized management system. Alternatively, there may be a function of the product deployed in the associated dispensing unit that initiates communication between the vending machine(s) and the centralized management system. The thresholds could be set locally on the machine or remotely by the centralized system depending on the implementation or the manufacture. The counting or inventory information would need to be reset at appropriate times (for example, when the items are stocked), resetting on the data collection module could mimic reset buttons found on mechanical coin copying machines, or be done electronically, which allows resetting to be done remotely.

Referring to FIG. 4 appended hereto, there is shown a bulk-vending machine 10 of the type depicted in a circular entitled, “The Unique, Interchangeable Canister” such as the machine produced by Vendstar 3000. As one can ascertain, the vending machine 10 has a canister 12, which is filled with an item to be dispensed, such as bulk candy and so on. The canister is also associated with a gear 11. When the canister is inserted into the opening 15 of the base of the machine, the gear 11 meshes with gear 19 that interfaces with a front knob 16. The knob 16 is positioned below a coin slot 17. A flap 18 enables a consumer to receive the dispensed product, which as shown in the circular, can be M&M's, pistachios or some other type of candy or product. The operation of such machines can be easily ascertained. The dispensing machine 10, as well as many other dispensing machines, enables a user to insert a coin into the coin slot 17 and when the coin is inserted, the user then turns the knob 16, which turns gear 19 that meshes with the gear 11. The knob 16 turns and performs a revolution or multiple revolutions. The gear 11 is moved into a position where an opening occurs between the dispenser and a chute, which is not shown, and the chute interfaces with an opening beneath the flap 18, which enables a user (after insertion of the coin) to lift the flap 18 and receive the dispensed product. This operation is extremely well known and essentially has been described above.

In any event, shown in FIG. 4 is a gear 20, which is coupled to a counter 21. The gear 20 is also coupled to the gear 19, which will cause the counter 21 to advance 1 count for each coin received by the machine. The counter 21 may be mechanical or electrical. If a mechanical counter is used, the output can be converted to an electrical signal by many well-known techniques. The output of the counter is directed to an input of a processor 22, which may, for example, be a microprocessor or any processing device. Also shown coupled to the processor 22 are two additional inputs designated as 23 and 25, which, for example, may come from the other dispensing units or canisters associated with the vending machine 10. As, for example, shown in the enclosed circular, there are three dispensing units in one machine. It is, of course, understood that there can be more than three and so on. Essentially, the processor 22 can process signals from all dispensers in each vending machine or each different unit in each machine may have its own processor and circuitry. Also coupled to the output of the processor is a remote device 24, which basically is a wireless transmitting device, which can transmit a signal, as is well known, to a remote location, which would be the central management location. It is understood that a wired transmitter could be used as well, for example, over a telephone line or other transmission medium. The remote device 24 may also contain a receiver and can be operated by the central location to cause the processor to transmit the status to the vending machine based on the received command from the central location.

In summation, the device operates as follows. Upon rotation of the gear 19, which is associated with the depositing of the coin, the gear 20 interfaces with the counter to add one count for a dispensing rotation of gear 20. This would indicate that one coin has been deposited and therefore one volume of contents has been released from the machine. The processor can store this count and compare this count with a predetermined threshold count. This applies to each of the canisters. In this manner, the processor, for example, will indicate that canister 12 has dispensed 50 volumes and therefore has collected, for example, 50 coins (threshold number) and the remaining amount may constitute another ten volumes and therefore, the canister has to be refilled. When the threshold is reached the processor will activate the remote device 24 to transmit a signal to the remote location. The signal transmitted can be indicative of the need to fill the machine and may include, of course, the identity of the machine and the location of the machine, as well as many other indications so that the central location can accurately locate and monitor the machine.

In addition, the wireless module could periodically check the status of each dispensing unit's counter and if unchanged over a designated period, it could indicate a possible jam or problem with the associated dispenser unit. In either situation, the signal transmitted can be indicative of the need to fill/repair the machine and may include, of course, the identity of the machine and the location of the machine, as well as many other indications so that the central location can accurately locate and monitor the machine. It is, of course, understood that there are numerous ways of implementing the remote device 24 operation, including many different modes of transmission.

In any event, each dispensing unit will have such information stored in the processor and therefore, the central management may make a decision based on the transmitted results. The decision could be to transport a new container and to also be aware of the fact that the monitored machine canister has now collected 50 coins. Therefore, the management would have an accurate idea of the amount of income derived from that particular canister at that particular location. The invention has been explained above and as seen from the Figures, it is one way of implementing the same. It would be, of course, understood to one skilled in the art that there are alternate ways of implementing the invention and a preferred embodiment is briefly shown.

### DYNAMIC SERVICE ROUTE INVENTION: DETAILED DESCRIPTION

Prior to service routes being dynamically generated, central headquarters calls each machine and determines its status.

Central headquarters then selects (either manually or automatically) those machines that are targeted for service as well as the skill level required to service each machine. Headquarters may, if desired, remove or add machines from the machines proposed for servicing.

Once the machines are selected, the centralized management system generates ONE “first cut” service route template that provides the shortest route connecting all the machine locations and central headquarters using the well known Traveling Salesman Algorithm techniques that are abundant in the mathematical/computer science literature. Such algorithms require that the distance between the locations be known and such information is readily available from the Global Positioning Satellite mapping software.

Such a “first cut” service route provides the best route without any constraints and acts as a template for the centralized management system to allocate service routes to employees based on employee hours, employee skill level and vending machine location accessibility hours. The modification of the “first cut” service route template is what constituents this dynamic service route invention.

Once the “first cut” service route template is established, the centralized management system's database checks the hours and skill level of the employees available for that day, and if unknown, the hours and/or skill level are provided manually.

Finally, the accessibility hours for any machine that may that changed location (detected by a change in its Global Positioning Satellite Location data) is requested and provided manually or by some other means.

The centralized management system then allocates machines along the “first cut” service route template to employees as follows:
Starting with the lowest skill level “After-hour employees” are sequentially assigned to the machines along the route that are open during such after hours until all “After-hour employees” are fully utilized or no further machines are available to be serviced in the “After-hour” timeframe at this skill level. Clearly the allocation of machines to employees will need to account for the time to return the servicing materials to the centralized location and such information is readily available using Global Satellite Position mapping software (such as Mapquest, for example).
“After-hour employees” whose hours also span “Normal Working hours” are then assigned machines that are closest (to minimize distance traveled) to the machines already allocated to them and so that the time the employee is on the road is minimized. Before such a “candidate” machine is added to a target employee's route, a check must be made to ascertain that the machine is available for servicing at the time the employee is expected to arrive at the location. Such a check is readily executed by utilizing Global Positioning Satellite mapping software (such as Mapquest for example), that provides the time needed to travel to different locations. If the “candidate” machine is not accessible about the time of arrival, then this machine is removed as a possible candidate for this target employee to service. Above logic is repeated with the remaining candidate machines on the route for this target employee. Such allocation of machines is continued until all such employees are fully utilized or there is a determination that no further machines can be serviced by employees working these irregular hours with these skill levels.
Before allocating “Normal working hour” employees, the centralized management system provides the utilization level of all “After-hour employees”. A decision is then made on whether or not employees being utilized sufficiently for them to “hit the road”. If not, management removes such employees from the employees available for servicing that day and the central management system restarts/modifies its allocation process to the “After-hour employee” pool until central headquarters is comfortable with the utilization of its After-hour employees. The central management system then proceeds to allocate “Normal working hour” employees to service routes, starting with part-time employees first.
“Normal working hour” employees are allocated to the remaining machines so that the total number of hours employees are on the road is minimized. Such an allocation is straightforward, the first employee gets the first set of machines remaining on the “first cut” service route template until he is fully utilized, the next employee the next set, and so on and so forth. The logic for allocating machines to “Normal working hour” employees commences with part-time employees with the lowest skilled employees and moving up the skill level to the highest skill. Full-time employees are then treated is a similar manner with lowest skilled employees being allocated service routes first, and then moving on to higher skilled employees.
The highest skill level employee is the most flexible and so his/her time on the road is minimized since this employee is flexible to pursue other projects being initiated by central headquarters.
When the service routes are assigned, the centralized management system provides the utilization level of all employees. A decision is then made on whether some employees are not being utilized sufficiently for them to “hit the road”. If not, management removes such employees from the employees available for servicing that day and the central management system restarts/modifies its allocation process until central headquarters is comfortable with the utilization of employees.

It is, of course, understood to one skilled in the art that there are alternate ways of implementing the dynamic service route algorithm and simply a preferred execution has been described.

Once the service routes are assigned, Global Positioning Satellite Software (such as Mapquest for example) dynamically generates the service route for each employee, with directions and the equipment/supplies needed to execute the service route. The equipment/supplies needed for servicing is readily derived from the status of the machines on the route.

When fully utilized this centralized management system will typically generate different service routes that attempts to optimize employee resources by ensuring that machine that truly are in need of service, are checked and doing so in a manner that minimizing employee costs and travel time. In this manner, the conflicting constraints that define business profitability trade-offs can be fully explored.

1. In a vending machine for dispensing articles upon insertion of a coin in a receptacle associated with said machine and operative to dispense a product when said coin is received by said machine, in combination therewith,
a counter for providing at an output count signal indicative of each coin received by said machine,
a processor for storing the count signal and for comparing the count signal with a programmed condition to provide an output when said count signal equates to said condition which may also be indicative of the receipt of a given number of coins, or which may be indicative of a dispenser jam,
a processor able to detect a condition that is indicative of a low battery,
transmitting means coupled to said processor and responsive to said processor output to transmit a signal to a central location informing said location that said condition has been met by said vending machine,
receiving and processing a signal from a central location to initiate transmission of the condition of the said machine, or to modify and update threshold(s) within the said processor, or to reset the said coin counter(s) for the various data modules within the said machine.

2. The vending machine according to claim 1 wherein said counter output is indicative of the amount of product dispensed.

3. The vending machine according to claim 1, wherein said knob is normally in a locked state and when a coin of predetermined type is inserted into said coin receptacle and said knob is rotated, the presence of the coin unlocks the knob allowing it to turn and advance the counter by one count through an input coupled to a gear in said machine.

4. The vending machine according to claim 1 wherein said transmitted signal includes information as to the Global Positioning Satellite/location of said machine.

5. The vending machine according to claim 4 wherein said transmitted signal includes information related to the serial number and/or identity number previously assigned by the centralized management system to said machine.

6. The vending machine according to claim 1 wherein said processor is a microprocessor.

7. The vending machine according to claim 1 wherein said transmitting means is typically wireless transmission, but wired transmission may be used.

8. The vending machine according to claim 1 wherein said transmitting means includes receiving means for remotely operating said transmitting means at said central location.

9. The vending machine according to claim 1 wherein said programmed condition is a stored threshold count indicative of a given number of received coins and the stored threshold(s) can be remotely updated, if desired.

10. The vending machine according to claim 1 wherein said programmed condition can include time period threshold(s) (over which no coins being received could be indicative of a dispenser jam or other issues of concern to management), which can be remotely updated, if desired.

11. This invention allows service routes to be generated DYNAMICALLY. Global Positioning Satellite technology is used to determine the distance between locations and the shortest route to service such locations, with no employee or location constraints via the Traveling Salesman algorithm (implementations of this algorithm are abundant in the mathematically and/or computer science literature). This invention uses the output of the Traveling Salesman algorithm to allocate employees to locations using a “greedy algorithm” heuristic, which can be iteratively modified by management to accommodate employee utilization thresholds/constraints. This algorithm SIMULTANEOUSLY addresses:
hours of employees,
hours of site/location availability,
skill level of each employee, and
management employee utilization thresholds.
Utilization thresholds of employees have priority over delivery deadlines in the vending business as management has considerable control and modification of delivery deadlines.

12. The algorithm is applicable to any business desirous of generating dynamic service routes and as such the algorithm is not constrained to just the vending machine business.
